(19) United States
(12) Patent Application Publication
(10) Pub. No.: US 2016/0214389 A1
(43) Pub. Date: Jul. 28, 2016

(54) INKJET RECORDING APPARATUS

(71) Applicant: CANON KABUSHIKI KAISHA, Tokyo (JP)

(72) Inventors: Tsuyoshi Saeki, Kawasaki-shi (JP); Noboru Shimoyama, Yokohama-shi (JP)

(21) Appl. No.: 15/002,218

(22) Filed: Jan. 20, 2016

(30) Foreign Application Priority Data
Jan. 26, 2015 (JP) PCT/JP2015/051962

(51) Int. Cl. B41J 2/175

(52) U.S. Cl. CPC B41J 2/1752

(57) ABSTRACT

An inkjet recording apparatus according to the present invention includes a first holding unit configured to hold an ink cartridge, and capable of moving between a first position which allows attachment and detachment of the ink cartridge and a second position which allows to supply ink from the ink cartridge to an ink passage in an apparatus body; a first biasing unit configured to bias the first holding unit in a first direction from the second position toward the first position; a restricting unit configured to restrict movement of the first holding unit at the second poson in the first direction; and a second holding unit configured to move as the first holding unit moves, and hold the ink cartridge at the second position by sandwiching the ink cartridge between the second holding unit and the first holding unit.

### TECHNICAL FIELD

The present invention relates to an inkjet recording apparatus.

### BACKGROUND ART

Patent Literature 1 discloses a configuration in which an apparatus body has a retaining pin and an ink cartridge has a guide groove for guiding the retaining pin, whereby the ink cartridge can be easily attached to and detached from the apparatus body without using an attachment/detachment lever.

### CITATION LIST

### Patent Literature

PTL 1 Japanese Patent Laid-Open No. 2005-59317

In the configuration described in Patent Literature 1, the guide groove needs to be created directly in the ink cartridge. This means that it is difficult to simplify the shape of the ink cartridge. For example, to simplify the shape of the ink cartridge, the ink cartridge may be formed by blow molding. However, it is difficult by blow molding to form a complex shape, such as that of the guide groove described above. Also, when the guide groove is created directly in the ink cartridge, the ink cartridge is always retained by the retaining pin while the ink cartridge is in a mounted state. This may cause creep deformation of the ink cartridge and affect the attaching and detaching operation.

The present invention provides an inkjet recording apparatus which allows easy and reliable attachment and detachment of an ink cartridge, without the need of forming the ink cartridge in a complex shape.

### SUMMARY OF INVENTION

An inkjet recording apparatus according to the present invention includes a first holding unit configured to hold an ink cartridge, and capable of moving between a first position which allows attachment and detachment of the ink cartridge and a second position which allows to supply ink from the ink cartridge to an ink passage in an apparatus body; a first biasing unit for biasing the first holding unit in a first direction from the second position toward the first position; a restricting unit configured to restrict movement of the first holding unit at the second position in the first direction; and a second holding unit configured to move as the first holding unit moves, and to hold the ink cartridge at the second position by sandwiching the ink cartridge between the second holding unit and the first holding unit.

Further features of the present invention will become apparent from the following description of exemplary embodiments with reference to the attached drawings.

### BRIEF DESCRIPTION OF DRAWINGS

FIG. 1 is an external perspective view of an inkjet recording apparatus according to the present invention.

FIG. 2 is a cross-sectional view of a mounting unit in an ink-cartridge mounted state.

FIG. 3 is a perspective view of the mounting unit in an ink-cartridge unmounted state.

FIGS. 4A and 4B are each a bottom view of a restricting unit.

FIGS. 5A and 5B illustrate a pivoting holder located at a restricting position and a retracted position.

FIG. 6 illustrates another form of the pivoting holder.

FIG. 7 illustrates another form of the pivoting holder.

FIGS. 8A and 8B illustrate the mounting unit in the ink-cartridge unmounted state.

FIGS. 9A and 9B illustrate the mounting unit during insertion of the ink cartridge.

FIGS. 10A and 10B illustrate the mounting unit in the ink-cartridge mounted state.

FIGS. 11A and 11B illustrate the mounting unit during removal of the ink cartridge.

FIG. 12 is a cross-sectional view of a mounting unit according to a second embodiment.

FIG. 13 is a cross-sectional view of a mounting unit according to a third embodiment.

### DESCRIPTION OF EMBODIMENTS

### First Embodiment

A first embodiment of an inkjet recording apparatus according to the present invention will now be described in detail with reference to the drawings.

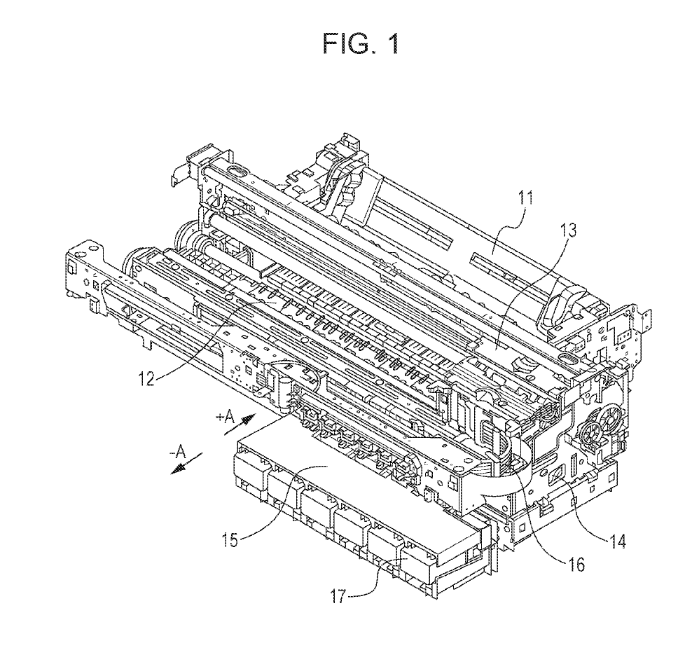

FIG. 1 is a perspective view illustrating a general configuration of an inkjet recording apparatus according to the present invention. The inkjet recording apparatus primarily includes a feeding unit 11, a conveying unit 12, a carriage unit 13, a recovery mechanism 14, an ink cartridge mounting unit 15, and an ink passage unit 16. The mounting unit 15 is a portion to and from which an ink cartridge 17 is attached and detached. In the present embodiment, the mounting unit 15 is disposed at the front of the apparatus body. The attachment and detachment of the ink cartridge 17 can be performed on the front side of the apparatus body. A direction shown in FIG. 1 is an insertion direction in which the ink cartridge 17 is inserted, and a -A direction shown in FIG. 1 is a removal direction in which the ink cartridge 17 is removed. The ink cartridge may also be referred to as an ink tank.

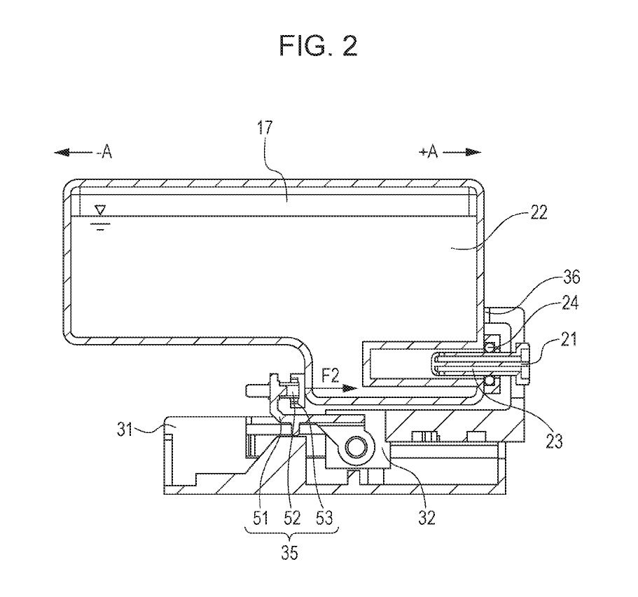

FIG. 2 is a cross-sectional view of the mounting unit 15 in an ink-cartridge mounted state. The apparatus body has an ink supply needle 21. The ink supply needle 21 has an ink supply port 23 communicating with ink 22 in the ink cartridge 17. In the ink-cartridge mounted state, the ink 22 is supplied from the ink supply port 23, through the passage unit. 16 having an ink passage, to the carriage unit 13 of the apparatus body. Sealing between the apparatus body and the ink cartridge 17 is formed by bringing the inner periphery of a sealing portion 24 of the ink cartridge 17 and the outer periphery of the ink supply needle 21 into close contact with each other.

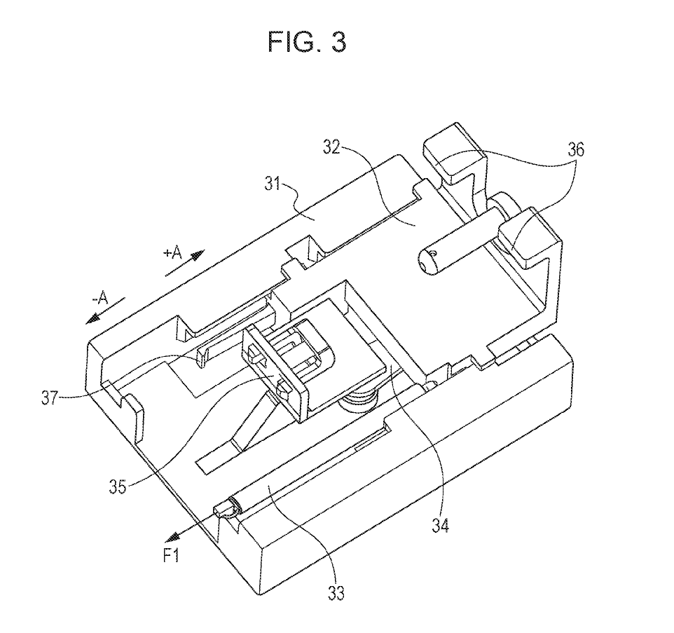

FIG. 3 is a perspective view of the mounting unit 15 in an ink-cartridge unmounted state. The mounting unit 15 primarily includes a housing 31, a sliding holder 32 (first holding unit), a spring 33 (first biasing unit), a restricting unit 34, and a pivoting holder 35 (second holding unit).

The sliding holder 32 is for holding the ink cartridge. The sliding holder 32 is held by the housing 31. The sliding holder 32 can linearly move (or slide) in the insertion direction (second direction) and the removal direction (first direction) of the ink cartridge. The sliding holder 32 slides to move between a first position which allows attachment and detachment of the ink cartridge, and a second position at which the ink cartridge is mounted on the apparatus body to allow supply of the ink from the ink cartridge to the ink passage. The insertion direction (second direction) is a direction from the first position toward the second position, and the removal direction (first direction) is a direction from the second position toward the first position.

The sliding holder 32 is biased in the first direction by the spring 33. In the ink-cartridge unmounted state, the sliding holder 32 is stopped when a contact surface 37 biased by the spring 33 comes into contact of with the housing 31.

During insertion of the ink cartridge 17, the sliding holder 32 moves together with the ink cartridge 17 in the second direction while a protruding portion 36 is being in contact with the ink cartridge 17. A biasing force F1 of the spring 33 is sufficient to press and move the ink cartridge 17 to the first position during removal of the ink cartridge. In the present embodiment, the biasing force F1 of the spring 33 is about 6 N.

The restricting unit 34 is for restricting movement of the sliding holder 32 in the first direction when the ink cartridge is mounted and the sliding holder 32 is located at the second position. The restricting unit 34 has a guide pin 42 (retaining pin). The sliding holder 32 has a guide groove 41. The guide pin 42 is pivotably attached to the housing 31, and is configured to allow an end thereof to move along the guide groove 41.

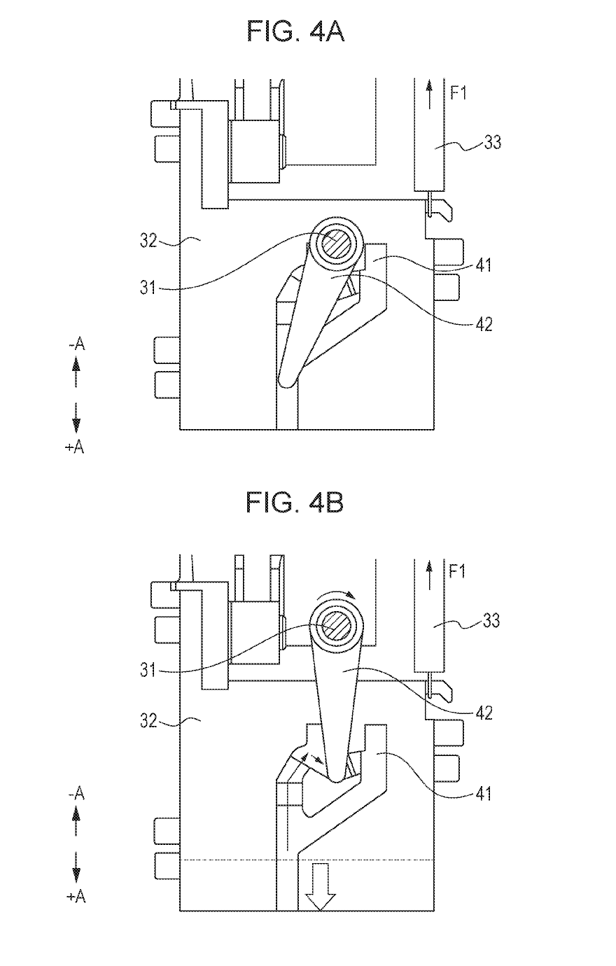

FIGS. 4A and 4B are each a bottom view of the restricting unit 34 as viewed from below the main body. In the ink-cartridge unmounted state, as illustrated in FIG. 4A, the guide groove 41 and the guide pin 42 are not retained with respect to each other. At this point, the sliding holder 32 is slidable in the second direction and the first direction. As described above, the sliding holder 32 is at rest because the biasing force F1 of the spring 33 causes the contact surface 37 to be in contact with the housing 31. In the ink-cartridge mounted state, as illustrated in FIG. 4B, the guide pin 42 is retained in a recessed portion (retaining portion) of the guide groove 41. This causes the sliding holder 32 to come to rest, with the guide pin. 42 and the guide groove 41 being in contact with each other.

The pivoting holder 35 is configured to hold the ink cartridge 17 by sandwiching it between the pivoting holder 35 and the sliding holder 32, which is holding the ink cartridge 17 at the second position. The ink cartridge 17 is held by being sandwiched between the sliding holder 32 and the pivoting holder 35, whereby stable mounting of the ink cartridge 17 can be ensured. As illustrated in FIG. 2, the pivoting holder 35 includes a lever 51, a lever spring 52 (second biasing unit), and a contact member 53. The lever 51 is pivotably held by the sliding holder 32. The contact member 53 is provided in the lever 51, with the lever spring 52 interposed therebetween, and is configured to be pivotable with the lever 51.

In the ink-cartridge mounted state, the ink cartridge 17 is biased by the lever spring 52 in the second direction, with the contact member 53 interposed therebetween. The ink cartridge 17 and the protruding portion 36 are thus kept in contact with each other, and this ensures stable mounting of the ink cartridge 17 on the apparatus body. Since the lever 51 is held by the sliding holder 32, a biasing force F2 of the lever spring 52 can be set to an appropriate value without being affected by the biasing force F1 of the spring 33. In the present embodiment, the biasing force F2 of the lever spring 52 is about 3 N.

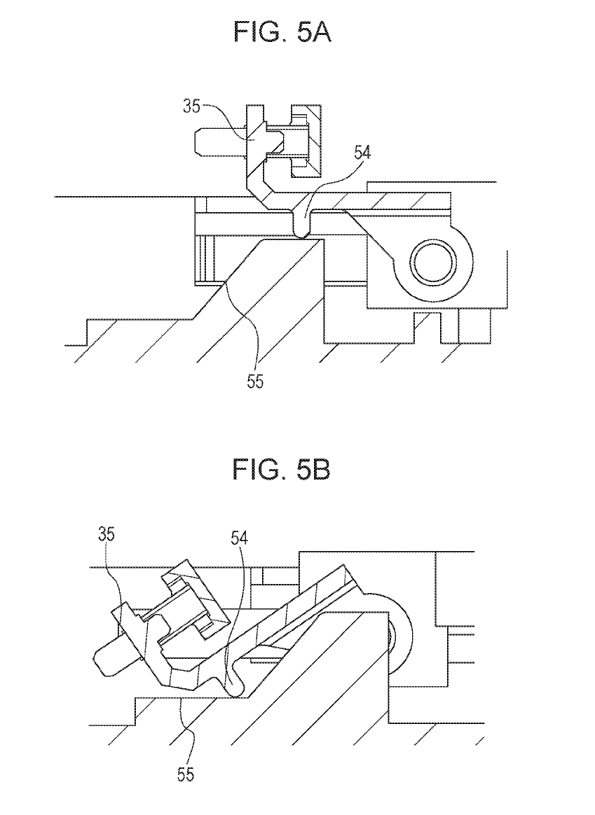

The pivoting holder 35 moves as the sliding holder 32 moves. When the sliding holder 32 moves to the second position, the pivoting holder 35 moves to a holding position at which the ink cartridge is held. On the other hand, when the sliding holder 32 moves to the first position, the pivoting holder 35 moves to a retracted position which does not interfere with the attaching and detaching operation of the ink cartridge 17. FIG. 5A illustrates the pivoting holder 35 located at the holding position, and FIG. 5B illustrates the pivoting holder 35 located at the retracted position. The housing 31 has a cam portion 55, and the lever 51 has a follower portion 54 which slides along the cam portion 55. As the sliding holder 32 linearly moves (or slides), the lever 51 of the pivoting holder 35 pivots to move between the holding position and the retracted position.

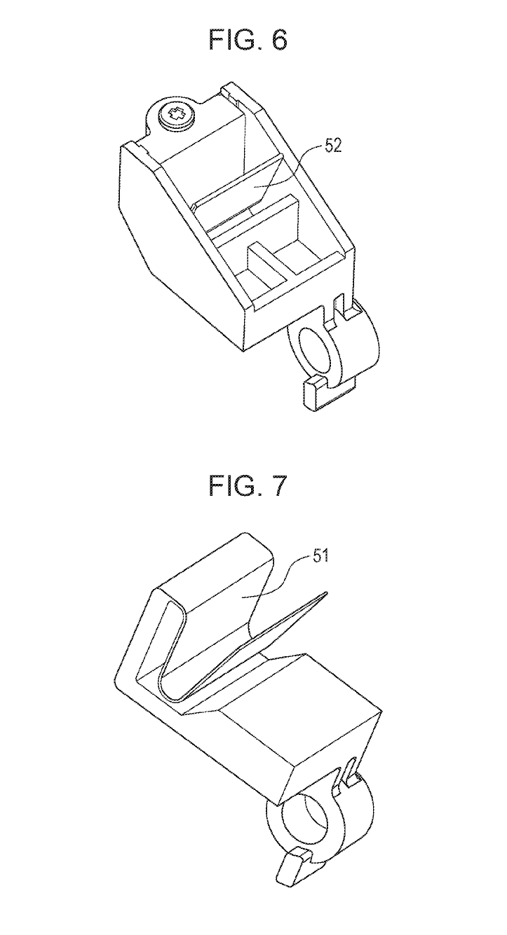

The pivoting holder 35 includes the contact member 53 for contact with the ink cartridge 17 in the present embodiment. However, as illustrated in FIG. 6, the lever spring 52 may be directly brought into contact with the ink cartridge 17. As illustrated in FIG. 7, the lever 51 may have an elastic portion which is brought into contact with the ink cartridge 17. The ink cartridge 17 may be directly brought into contact with the contact surface of the lever 51, without a biasing unit such as the lever spring 52.

The mounting unit 15 during an attaching and detaching operation of the ink cartridge will now be described.

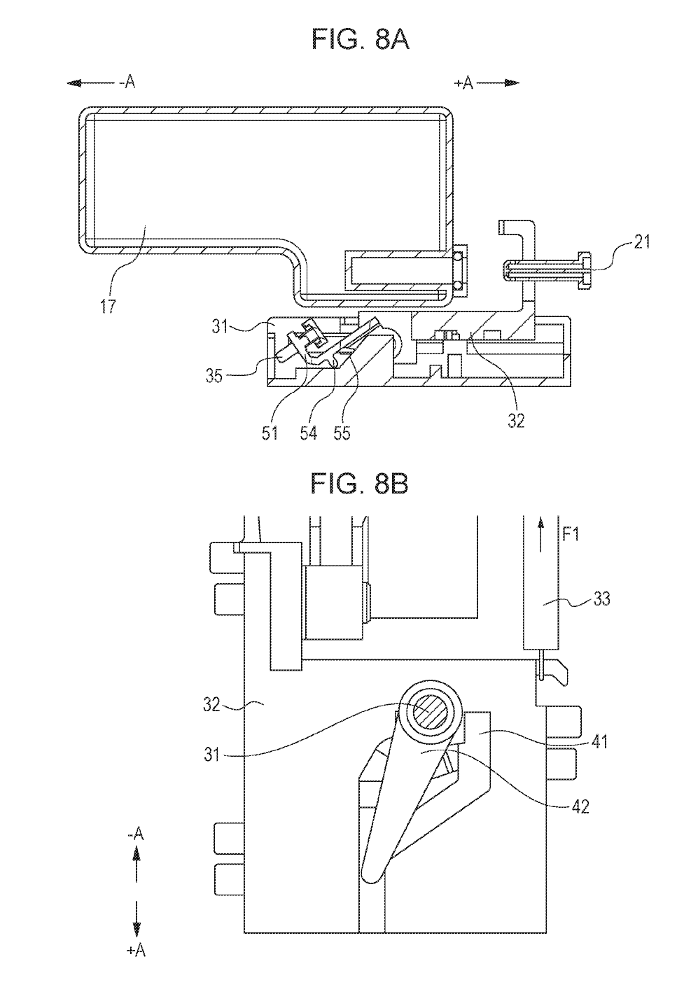

FIGS. 8A and 8B to FIGS. 11A and 11B illustrate each part of the mounting unit 15 in each stage of an attaching and detaching operation of the ink cartridge. In these drawings, FIGS. 8A, 9A, 10A, and 11A are each a cross-sectional view of the mounting unit 15, and FIGS. 8B, 9B, 10B, and 11B are each a bottom view of the restricting unit 34. A state of each part in the following four stages of an attaching and detaching operation of the ink cartridge will be described: (1) in the ink-cartridge unmounted state, (2) during insertion of the ink cartridge, (3) in the ink-cartridge mounted state, and (4) during removal of the ink cartridge.

(1) In Ink-Cartridge Unmounted State

FIGS. 8A and 8B illustrate the mounting unit 15 on which the ink cartridge 17 is not mounted. As illustrated in FIG. 8A, the sliding holder 32 is biased in the first direction by the spring 33 and kept at rest, with the contact surface 37 being in contact with the housing 31. At this point, the sliding holder 32 is located at the first position which allows attachment and detachment of the ink cartridge 17. The pivoting holder 35 is at rest at the retracted position which does not interfere with the mounting operation of the ink cartridge. Since the guide pin 42 is not retained in the guide groove 41 as illustrated in FIG. 8B, the sliding holder 32 is movable in the second direction.

(2) During Insertion of Ink Cartridge

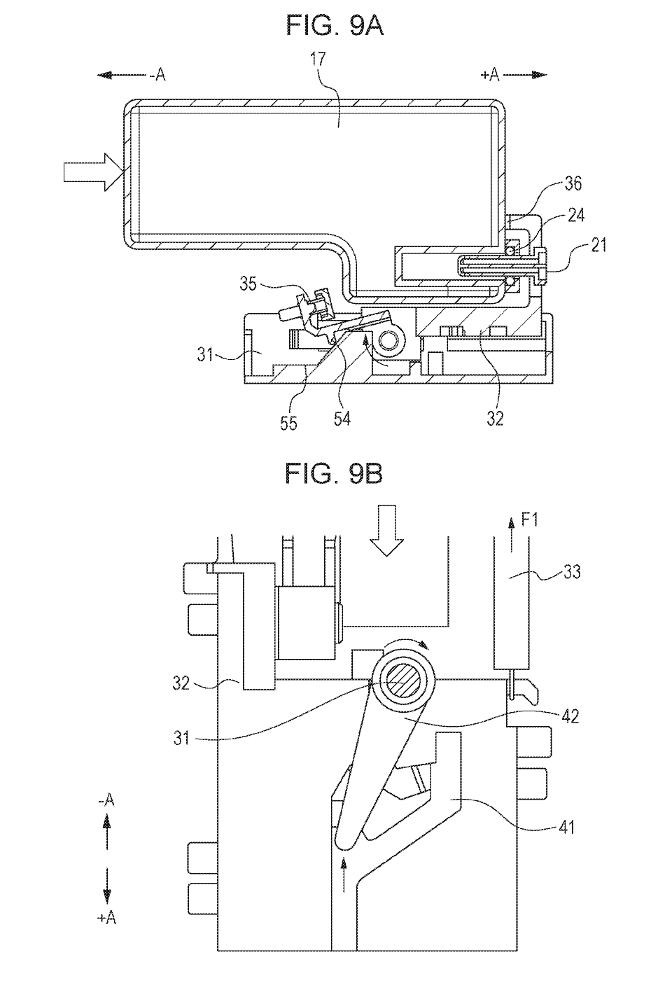

FIGS. 9A and 9B illustrate the mounting unit 15 during insertion of the ink cartridge. As illustrated in FIG. 9A, the ink cartridge 17 is inserted and brought into contact with the protruding portion 36, whereby the sliding holder 32 is pushed and moved in the second direction against the biasing force F1 of the spring 33. As the sliding holder 32 moves in the second direction, the pivoting holder 35 pivots toward the holding position for holding the ink cartridge. At the same time, as illustrated in FIG. 9B, the guide pin 42 of the restricting unit 34 moves along the guide groove 41. Since the guide pin 42 has not been retained in the guide groove 41 at this point, the sliding holder 32 is still in a movable state.

(3) In Ink-Cartridge Mounted State

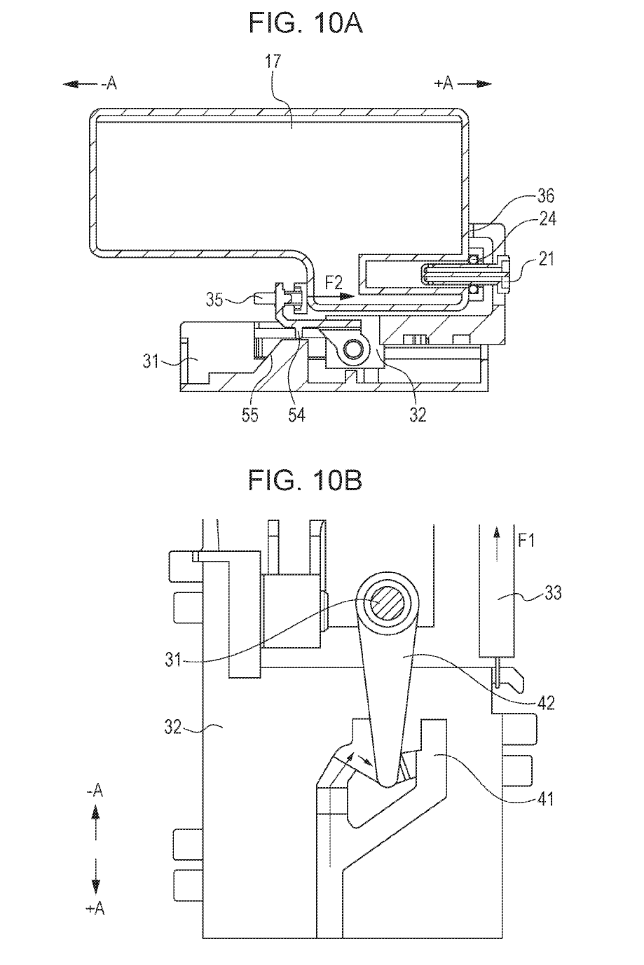

FIGS. 10A and 10B illustrate the mounting unit 15 in the ink-cartridge mounted state. As illustrated in FIG. 10B, the guide pin 42 is retained in the recessed portion (retaining portion) of the guide groove 41. This restricts movement of the sliding holder 32 in the first direction. Therefore, even though the sliding holder 32 is biased in the first direction by the spring 33, the sliding holder 32 comes to rest at the second position at which the ink cartridge is mounted. As illustrated in FIG. 10, the pivoting holder 35 is located at the holding position at which the ink cartridge is held. The ink cartridge 17 is biased in the second direction by the lever spring 52 included in the pivoting holder 35. This allows the ink cartridge 17 and the protruding portion 36 to be kept in contact with each other. The ink cartridge 17 is thus held by being sandwiched between the sliding holder 32 and the pivoting holder 35, whereby a stable mounted state of the ink cartridge can be maintained.

(4) During Removal of Ink Cartridge

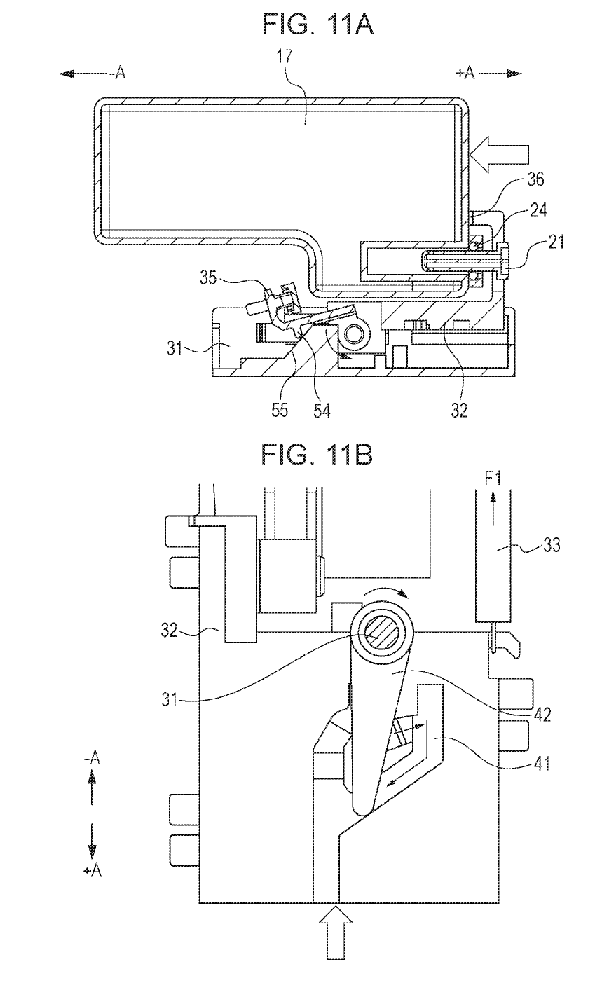

FIGS. 11A and 11B illustrate the mounting unit 15 during removal of the ink cartridge. When the ink cartridge 17 in the mounted state is pushed in, the guide pin 42 is moved out of the recessed portion (retaining portion) of the guide groove 41 as illustrated in FIG. 11B, whereby the guide pin 42 and the guide groove 41 are disengaged from each other. This makes the sliding holder 32 movable in the first direction. Thus, as illustrated in FIG. 11A, the sliding holder 32 is moved in the first direction by being biased by the spring 33. Together with the sliding holder 32, the ink cartridge 17 is pushed out in the first direction. The sliding holder 32 then moves to the first position which allows attachment and detachment of the ink cartridge 17. As the sliding holder 32 moves in the first direction, the pivoting holder 35 pivots to the retracted position which does not interfere with the attaching and detaching operation of the ink cartridge 17.

The mounting unit 15 during the attaching and detaching operation of the ink cartridge according to the present embodiment is as described above.

Although the sliding holder 32 which linearly moves has been described as a first holding unit in the present embodiment, the first holding unit does not necessarily need to linearly move. For example, the first holding unit may be configured to move in an arc. Although the pivoting holder 35 which pivots has been described as a second holding unit in the present embodiment, the second holding unit does not necessarily need to pivot. For example, the second holding unit may be configured to linearly move upward.

The present invention can thus provide an inkjet recording apparatus which allows easy and reliable attachment and detachment of an ink cartridge, without the need of forming the ink cartridge in a complex shape. The present invention, which does not depend on the shape of the ink cartridge, is also effective for ink cartridges formed by blow molding particularly for simplifying their shapes.

### Second Embodiment

A second embodiment of the present invention will now be described. In the description of the second embodiment, the description of components common to those in the first embodiment will be omitted, and only the differences from the first embodiment will be described.

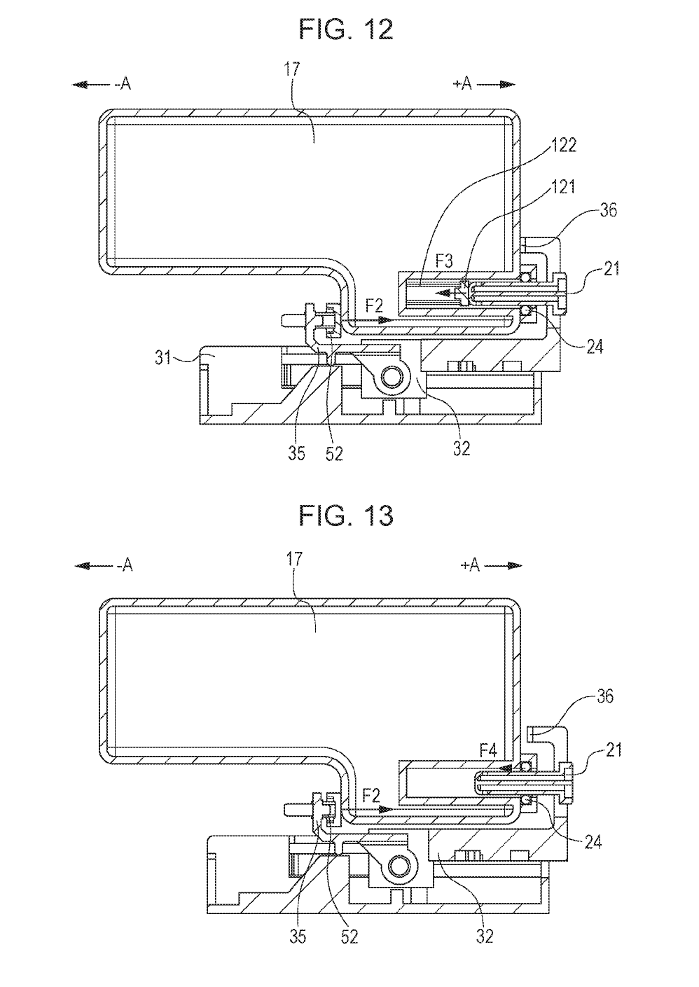

FIG. 12 is a cross-sectional view of a mounting unit according to the second embodiment. To prevent ink in the ink cartridge 17 from leaking during removal of the ink cartridge, the ink cartridge 17 has a valve member 121 that can come into contact with the sealing portion 24, as illustrated in FIG. 12. Additionally, the ink cartridge 17 has a sealing spring 122 (third biasing unit) that biases the valve member 121 to the sealing portion 24. In this mounted configuration, when the ink cartridge 17 is mounted on the mounting unit 15, the valve member 121 is pressed by an end of the ink supply needle 21, whereby the close contact between the sealing portion 24 and the valve member 121 is released. At this point, the ink cartridge 17 is biased by a biasing force F3 of the sealing spring in the removal direction (first direction). By satisfying the relational expression |F2|>|F3|, the protruding portion 36 and the ink cartridge 17 can be kept in contact with each other.

With the present configuration, leakage of ink from the ink cartridge 17 can be prevented in the unmounted state where the ink cartridge is not mounted on the apparatus body. Also, in the ink-cartridge mounted state, the ink cartridge 17 and the protruding portion 36 can be kept in contact with each other, and stable mounting of the ink cartridge can be ensured.

### Third Embodiment

A third embodiment of the present invention will now be described. In the description of the third embodiment, the description of components common to those in the above-described embodiments will be omitted, and only the differences from the above-described embodiments will be described.

FIG. 13 is a cross-sectional view of a mounting unit according to the third embodiment in the ink-cartridge mounted state, when the ink cartridge 17 is moved in the removal direction (first direction) by a removing operation of the ink cartridge 17 or the like, the protruding portion 36 and the ink cartridge 17 are separated from each other as illustrated in FIG. 13. Insertion of the ink cartridge produces friction between the ink supply needle 21 and the sealing portion 24. In this case, when the biasing force F2 of the lever spring 52 and a maximum frictional force F4 satisfy the relational expression |F2|>|F4|, the protruding portion 36 and the ink cartridge 17 can he brought back into contact.

With the present configuration, even when the protruding portion 36 and the ink cartridge 17 are temporarily separated from each other in the ink-cartridge mounted state, the contact between them can be restored and stable mounting of the ink cartridge can be ensured.

The present invention can provide an inkjet recording apparatus which allows easy and reliable attachment and detachment of an ink cartridge, without the need of forming the ink cartridge in a complex shape.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of international Patent Application No. PCT/JP2015/051962, filed Jan. 26, 2015, which is hereby incorporated by reference herein in its entirety.

1. An inkjet recording apparatus comprising:
a first holding unit configured to hold an ink cartridge, and capable of moving between a first position which allows attachment and detachment of the ink cartridge and a second position which allows to supply ink from the ink cartridge to an ink passage in an apparatus body;
a first biasing unit configured to bias the first holding unit in a first direction from the second position toward the first position;
a restricting unit configured to restrict movement of the first holding unit at the second position in the first direction; and
a second holding unit configured to move as the first holding unit moves, and to hold the ink cartridge at the second position by sandwiching the ink cartridge between the second holding unit and the first holding unit.

2. The inkjet recording apparatus according to claim 1, further comprising a second biasing unit included in the second holding unit, the second biasing unit being configured to bias the ink cartridge at the second position in a second direction from the first position toward the second position.

3. The inkjet recording apparatus according to claim 2, further comprising an ink supply needle for supplying ink from the ink cartridge to the ink passage,
wherein the ink cartridge has a third biasing unit configured to bias the ink cartridge in the first direction by coming into contact with the ink supply needle, and
wherein a force with which the second biasing unit biases the ink cartridge is greater than a force with which the third biasing unit biases the ink cartridge.

4. The inkjet recording apparatus according to claim 2, further comprising an ink supply needle for supplying ink from the ink cartridge to the ink passage,
wherein the ink supply needle comes into contact with the ink cartridge at the second position, and
wherein when a frictional force is produced between the ink cartridge and the ink supply needle during movement of the ink cartridge in the second direction, a force with which the second biasing unit biases the ink cartridge is greater than the frictional force.

5. The inkjet recording apparatus according to claim 1, wherein the restricting unit has a retaining pin, the first holding unit has a guide groove for guiding the retaining pin, and the guide groove has a retaining portion for retaining the retaining pin at the second position.

6. The inkjet recording apparatus according to claim 1, wherein the second holding unit is configured to pivot as the first holding unit linearly moves in the second direction, and to hold the ink cartridge at the second position by sandwiching the ink cartridge between the second holding unit and the first holding unit.

7. The inkjet recording apparatus according to claim 1, wherein the ink cartridge is formed by blow molding.
